(19) United States
(12) Patent Application Publication
(10) Pub. No.: US 2026/0146717 A1
(43) Pub. Date: May 28, 2026

(54) DRAG REDUCTION FORMULATION AND A METHOD FOR PREPARATION THEREOF

(71) Applicant: HINDUSTAN PETROLEUM CORPORATION LIMITED, Bangalore (IN)

(72) Inventors: Monikangkana Talukdar, Bengaluru (IN); Nilesh Rajesh Mote, Bengaluru (IN); Yogesh Popatrao Patil, Bengaluru (IN); Bennet Chelliahn, Bengaluru (IN); Srinivasa Narasimha Sheshachala, Bengaluru (IN)

(21) Appl. No.: 19/084,323

(22) Filed: Mar. 19, 2025

(30) Foreign Application Priority Data
Nov. 25, 2024 (IN) 202441091555

(51) Int. Cl. F17D 1/17; C08F 10/14; C08F 210/02; C08F 210/06; C08F 220/06; C08K 5/098; C08L 91/00; C09K 8/00

(52) U.S. Cl. CPC F17D 1/17; C08F 10/14; C08F 210/02; C08F 210/06; C08F 220/06; C08K 5/098; C08L 91/00; C09K 8/00; C08L 2205/025; C08L 2205/03; C09K 2208/28

(57) ABSTRACT

The present invention relates to a drag reduction formulation and a method for preparation thereof. The present invention more particularly relates to a drag reduction formulation having an improved drag reduction performance at even very low concentration, an excellent dispersion stability, and an enhanced shear stability over a wider shear range, and a method for preparation thereof through a simple, a less labour intensive, and a cost-effective method steps. The present invention also relates to an application of the drag reduction formulation in fluid systems particularly in transportation of the petroleum finished products through pipelines or conduits.

### CROSS REFERENCE TO RELATED APPLICATIONS

This application is a Nonprovisional application claiming priority to Indian Patent Publication No. 202441091555, filed on Nov. 25, 2024, which is incorporated by reference in its entirety herein.

### FIELD OF THE INVENTION

The present invention relates to a field of petroleum. In particular, the invention relates to transportation of petroleum and more specifically relates to a drag reduction formulation and a method for preparation thereof. The drag reduction formulation described herein is having an improved drag reduction performance, an excellent dispersion stability, and an enhanced shear stability over a wider shear range.

### BACKGROUND OF THE INVENTION

Petroleum products play an extremely important role in modern industry, and transportation of the petroleum products to the storage for further process to use of crude oil and finished oil. Approximately 60% of the world's oil production derives from offshore operations, also in very deep waters up to at least 8000 meters. Thus, pipelines for introducing additives to oil well heads and transporting oil to gathering structures are also exceptionally long and often flexible. When a fluid, such as a liquid hydrocarbon, is fed through a conduit, friction resulting from the fluid stream causes a pressure drop, which increases with the distance from the point(s) of feeding of the liquid hydrocarbon. Such a friction loss is known as drag, and said friction loss/drag increases the energy and equipment costs required for fluid transportation through the conduit.

Though pipeline transportation has the advantages of space saving, low energy consumption, little pollution, little limitation by geography and meteorological conditions, and the like, and is developed into an optimal transportation mode of petroleum and natural gas. However, there is also a serious disadvantage in that the transport capacity viz. the pipeline transportation is far less flexible than in other ways. The available solutions to overcome the aforementioned disadvantages comprise pipeline transformation into a number of auxiliary pipes, which eventually leads to an increased equipment investment; and requires multiple drag reducer injecting channels into the pipeline. Obviously, the best solution is to use drag reducers, which are more economical, faster and most manoeuvrable.

The drag reducer used in the current industry is mainly a linear polymer drag reducer, has the advantages of wide application range, good application effect, high molecular weight, good oil solubility and high drag reduction rate. But linear polymeric drag reducing agents are susceptible to shear degradation during application viz. after the drag reducer passes through the high turbulence area of the pipeline, the macromolecular covalent bond of the drag reducer can be broken into low molecular weight polymers without or with poor drag reduction potential. In order to maintain the drag reduction effect, the drag reducer needs to be timely supplemented after the drag reducer passes through a high-shear area, which necessitates increased consumption of the drag reducer, which adversely impact the operational economy.

WO2001/088031 discloses a drag reducing agent composition and a process of preparation thereof. The disclosed composition comprises an alpha olefin polymer, a natural fat or natural oil and optionally a dispersion stabilizing agent such as a soap like substance. The art also discloses a method for reducing drag in hydrocarbon flowing through a conduit. However, the drag reducing agent composition of the reference comprises a high amount of the alpha olefin polymer to achieve desirable drag reduction into the conduit, in addition higher amount viz. the most preferably 20-80 ppm concentration of the drag reducing agent composition is required to achieve drag reduction.

U.S. Pat. No. 10,144,865B2 relates to a method of preparation of a drag-reducing additive and a use thereof in treatment of a subterranean formation, pipeline or gathering line of a gas or a liquid, wherein the additives are formed by a combination of the polymer with relatively high amount of surfactants or by a combination of a polymer and a surfactant with a solvent. However, proposed drag-reducing additive comprises a high amount of the polymer to achieve desirable drag reduction at subterranean level.

Drag reduction is crucial for enhancing operational efficacy and energy consumption in petroleum industry, particularly in pipeline transportation, drag-reducing formulations are of high significance. Available drag reducing formulations contain high concentrations of high molecular weight polymers to achieve the required drag reduction effect, resulting in an increased cost and potential environmental impact. In addition, active agents of the high molecular weight polymers have high viscosities and thus require high delivery line pressure. To attain required pressure in an extended length of the service pipeline, diameter of the pipeline is reduced. However, passage through long conduits having small diameters in unstable subsea conditions have high probability of plugging and separation of constituents. Although, problems related to separation of constituents could be addressed by addition of stabilizers, but addition of stabilizers like fatty acid salt at low temperatures typically increase the viscosity of the composition and thereby compromise its usability.

In view of the above identified problems and drawbacks associated with the drag reducing formulation known in the art, and there is an urgent and unmet need for a new drag reducing formulation, which reduces frictional resistance in fluid system particularly while transporting petroleum finished products or raw oil through pipelines or conduits. Accordingly, the present invention provides a drag reduction formulation with an improved drag reduction performance, a good dispersion stability, and an enhanced shear stability, and a method for preparation thereof.

### OBJECTIVES OF THE PRESENT INVENTION

The primary object of the present invention is to provide a drag reduction formulation and a method of preparation thereof.

Another objective of the present invention is to provide a drag reduction formulation having an improved drag reduction performance.

Yet another objective of the present invention is to provide a drag reduction formulation having a good dispersion stability, and an enhanced shear stability during turbulence.

Another objective of the present invention is to provide a drag reduction formulation having a better drag reduction performance even at very low concentration.

Yet another objective of the present invention is to provide a drag reduction formulation having better stabilization over a wider shear range.

Another objective of the present invention is to provide a cost-effective drag reduction formulation having a reduced energy requirement and an easy method for preparation thereof.

Yet another objective of the present invention is to provide a drag reduction formulation with an improved drag reduction performance even at very low concentration without compromising other properties viz. dispersion stability, and shear stability, during transportation of petroleum products or raw hydrocarbons feeds through pipelines in short-to-long range distances.

### SUMMARY OF THE PRESENT INVENTION

This summary is provided to introduce a selection of concepts in a simplified manner that is described elaborately in detailed description. This summary is neither intended to identify key or essential inventive concepts of the invention nor is it intended to determine the scope of the invention.

In an aspect of the present invention, there is provided a drag reduction formulation.

In another aspect of the present invention, there is provided a method for preparing a drag reduction formulation.

In yet another aspect of the present invention, there is provided a process for reducing drag in transportation of petroleum products or raw hydrocarbon feeds in a short-to-long range distances.

In one of the preferred aspects, the present invention provides a drag reduction formulation comprising: a) a dispersion medium in an amount of 40 wt. % to 55 wt. %; b) one or more α-olefin polymer in an amount of 15 wt. % to 25 wt. %; c) one or more olefin co-polymer in an amount of 10 wt. % to 20 wt. %; d) one or more ionomer in an amount of 1 wt. % to 10 wt. %; e) one or more partitioning agent in an amount of 5 wt. % to 15 wt. %; and f) one or more additives such as shear stabilizing agent in an amount of 0.1 wt. % to 1 wt. %.

In an aspect of the present invention provides a drag reduction formulation comprising: a) a dispersion medium; b) one or more α-olefin polymer; c) one or more olefin co-polymer; d) one or more ionomer; e) one or more partitioning agent; and f) one or more additives, wherein the dispersion medium comprises one or more fatty acid oil in an amount of 40 wt. % to 50 wt. %; and one or more dispersion agent in an amount of 1 wt. % to 5 wt. %, wherein the fatty acid oil is a vegetable oil selected from a group comprising castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof, and wherein the dispersion agent is selected from a group comprising 1-pentanol, 1-hexanol, 1-heptanol, n-octyl alcohol, n-nonyl alcohol, 1-decanol, and a combination thereof.

In another aspect of the present invention provides a drag reduction formulation comprising: a) a dispersion medium; b) one or more α-olefin polymer; c) one or more olefin co-polymer; d) one or more ionomer; e) one or more partitioning agent; and f) one or more additives, wherein the olefin polymer is an ultrahigh molecular weight polyalphaolefin polymer (poly α-olefin polymer) having a molecular weight more than 1.0×10⁷ Da and is selected from a group comprising poly(l-decene), poly(l-octene), poly(l-hexene), co-polymers thereof and a combination thereof; and wherein the olefin co-polymer (OCP) has a molecular weight not more than 1.5×10⁶ Da and is selected from a group comprising ethylene-co-propylene polymer, ethylene-co-vinylene polymer, hexene-co-dodecene polymer, octene-co-tetradodecene polymer, ethylene-1-butene copolymer, ethylene-1-hexene copolymer, and a combination thereof.

In yet another aspect of the present invention provides a drag reduction formulation comprising: a) a dispersion medium; b) one or more α-olefin polymer; c) one or more olefin co-polymer; d) one or more ionomer; e) one or more partitioning agent; and f) one or more additives, wherein the ionomer is selected from a sodium, or a lithium or a zinc salt of ethylene-methacrylic acid, ethylene-acrylic acid, ethylene-co-methacrylic acid, poly(ethylene-co-methacrylic acid), and a combination thereof.

In still another aspect of the present invention provides a drag reduction formulation comprising: a) a dispersion medium; b) one or more α-olefin polymer; c) one or more olefin co-polymer; d) one or more ionomer; e) one or more partitioning agent; and f) one or more additives such as shear stabilizing agents are selected from a group comprising sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.

In an aspect of the present invention provides a drag reduction formulation comprising: a) a dispersion medium; b) one or more α-olefin polymer; c) one or more olefin co-polymer; d) one or more ionomer; e) one or more partitioning agent; and f) one or more additives, wherein the partitioning agent is selected from a group comprising calcium stearate, magnesium stearate, zinc stearate, sodium stearate, clay, talc, silica, micronized wax, sodium stearyl fumarate, sodium behenate, and a combination thereof.

In one of the preferred aspects, the present invention provides a method for preparing a drag reduction formulation, said method comprising: (i) cryogrinding of polymers to obtain a mixture of polymer particles; (ii) separating the mixture of polymer particles in a size range of 300 μm to 600 μm followed by addition of a dispersion medium in an amount of 40 wt. % to 55 wt. %, one or more ionomer in an amount of 1 wt. % to 10 wt. % of, one or more partitioning agent in an amount of 5 wt. % to 15 wt. %, and one or more additives in an amount of 0.1 wt. % to 1 wt. %, to obtain a mixture; and (iii) homogenizing the mixture to obtain the drag reducing formulation.

In an aspect of the present invention the method for preparing a drag reduction formulation comprises (i) cryogrinding of polymers; (ii) separating the mixture of polymer particles followed by addition of a dispersion medium, one or more partitioning agent, and one or more additives; and (iii) homogenizing the mixture, and wherein the cryogrinding of polymers is carried out in liquid nitrogen and the polymers consists of one or more polyalphaolefin in an amount of 15 wt. % to 25 wt. %; and one or more olefin co-polymer (OCP) in an amount of 10 wt. % to 20 wt. %.

In an aspect of the present invention the method for preparing a drag reduction formulation comprises (i) cryogrinding of polymers; (ii) separating the mixture of polymer particles followed by addition of a dispersion medium, one or more partitioning agent, and one or more additives; and (iii) homogenizing the mixture, and wherein the dispersion medium in step (ii) comprises one or more fatty acid oil in an amount of 40 wt. % to 50 wt. %; and one or more dispersion agent in an amount of 1 wt. % to 5 wt. %, wherein the fatty acid oil is a vegetable oil selected from a group comprising castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof; and wherein the dispersion agent is selected from a group comprising 1-pentanol, 1-hexanol, 1-heptanol, n-octyl alcohol, n-nonyl alcohol, 1-decanol, and a combination thereof.

In another aspect of the present invention the method for preparing a drag reduction formulation comprises (i) cryogrinding of polymers; (ii) separating the mixture of polymer particles followed by addition of a dispersion medium, one or more partitioning agent, and one or more additives; and (iii) homogenizing the mixture, and wherein, the ionomer in step (ii) is selected from a sodium, or a lithium or a zinc salt of ethylene-methacrylic acid, ethylene-acrylic acid, ethylene-co-methacrylic acid, poly(ethylene-co-methacrylic acid), and a combination thereof.

In yet another aspect of the present invention the method for preparing a drag reduction formulation comprises (i) cryogrinding of polymers; (ii) separating the mixture of polymer particles followed by addition of a dispersion medium, one or more partitioning agent, and one or more additives; and (iii) homogenizing the mixture, and wherein the partitioning agent in step (ii) is selected from a group comprising calcium stearate, magnesium stearate, zinc stearate, sodium stearate, clay, talc, silica, micronized wax, sodium stearyl fumarate, sodium behenate, and a combination thereof.

In still another aspect of the present invention the method for preparing a drag reduction formulation comprises (i) cryogrinding of polymers; (ii) separating the mixture of polymer particles followed by addition of a dispersion medium, one or more partitioning agent, and one or more additives; and (iii) homogenizing the mixture, and wherein the additives in step (ii) are shear stabilizing agents selected from a group comprising sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.

In another aspect, the present invention provides a method for reducing a drag in a fluid system specifically hydrocarbon flowing in a pipeline or a conduit. The method is characterized by the steps of: (A) preparing a drag reducing formulation by (a) cryogrinding of polymers in liquid nitrogen to obtain a mixture of polymer particles; (b) separating the mixture of polymer particles in a size range of 300 μm to 600 μm followed by addition of a dispersion medium in an amount of 40 wt. % to 55 wt. %, one or more ionomer in an amount of 1 wt. % to 10 wt. %, one or more partitioning agent in an amount of 5 wt. % to 15 wt. %, and one or more additives in an amount of 0.1 wt. % to 1 wt. %; to obtain a mixture; and (c) homogenizing the mixture to obtain the drag reducing formulation; and (B) feeding the drag reducing formulation into a hydrocarbon transporting pipeline or conduit in an amount of 1-20 ppm, preferably 1-10 ppm, most preferably 1-5 ppm.

### DETAILED DESCRIPTION OF THE INVENTION

In an aspect of the present invention, there is provided a drag reduction formulation.

In an aspect of the present invention, there is provided a novel, a cost-effective, a less energy intensive and an easy method for preparing a novel drag reduction formulation.

In an aspect of the present invention, there is provided an effective method for reducing drag in a fluid system specifically hydrocarbon flowing in a pipeline or a conduit.

In one of the preferred aspects, the present invention provides a drag reduction formulation (DRF) comprising: a) a dispersion medium in an amount of 40 wt. % to 55 wt. %; b) one or more α-olefin polymer in an amount of 15 wt. % to 25 wt. %; c) one or more olefin co-polymer in an amount of 10 wt. % to 20 wt. %; d) one or more ionomer in an amount of 1 wt. % to 10 wt. %; e) one or more partitioning agent in an amount of 5 wt. % to 15 wt. %; and f) one or more additives in an amount of 0.1 wt. % to 1 wt. %.

In an aspect of the present invention, the dispersion medium comprises one or more fatty acid oil in an amount of 40 wt. % to 50 wt. %; and one or more dispersion agent in an amount of 1 wt. % to 5 wt. %, wherein the fatty acid oil is a vegetable oil selected from a group comprising castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof, and wherein the dispersion agent is selected from a group comprising 1-pentanol, 1-hexanol, 1-heptanol, n-octyl alcohol, n-nonyl alcohol, 1-decanol, and a combination thereof.

In another aspect of the present invention, the α-olefin polymer is an ultrahigh molecular weight poly-α-olefin polymer having a molecular weight more than 1.0×10⁷ Da and is selected from a group comprising poly(l-decene), poly(l-octene), poly(l-hexene), co-polymers thereof and a combination thereof; and wherein the olefin co-polymer (OCP) has a molecular weight not more than 1.5×10⁶ Da and is selected from a group comprising ethylene-co-propylene polymer, ethylene-co-vinylene polymer, hexene-co-dodecene polymer, octene-co-tetradodecene polymer, ethylene-1-butene copolymer, ethylene-1-hexene copolymer, and a combination thereof.

In yet another aspect of the present invention, the ionomer is selected from a sodium, or a lithium or a zinc salt of ethylene-methacrylic acid, ethylene-acrylic acid, ethylene-co-methacrylic acid, poly(ethylene-co-methacrylic acid), and a combination thereof.

In still another aspect of the present invention, the additives are shear stabilizing agents selected from a group comprising sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.

In an aspect of the present invention, the partitioning agent is selected from a group comprising calcium stearate, magnesium stearate, zinc stearate, sodium stearate, clay, talc, silica, micronized wax, sodium stearyl fumarate, sodium behenate, and a combination thereof.

In an aspect of the present invention, the olefin-co-polymer (OCP) offers rheology-control to the drag reduction formulation. Particularly, the olefin copolymer modifies the rheological properties of a fluid i.e. its viscosity and elasticity, and this modification reduces the energy loss due to turbulence, thus enhances an overall drag reduction.

In one of the preferred aspects, the present invention provides a method for preparing a drag reduction formulation (DRF), said method comprising: (i) cryogrinding of polymers in liquid nitrogen to obtain a mixture of polymer particles; (ii) separating the mixture of polymer particles in a size range of 300 μm to 600 μm followed by addition of a dispersion medium in an amount of 40 wt. % to 55 wt. %, one or more ionomer in an amount of 1 wt. % to 10 wt. %, one or more partitioning agent in an amount of 5 wt. % to 15 wt. %, and one or more additives in an amount of 0.1 wt. % to 1 wt. % to obtain a mixture; and (iii) homogenizing the mixture to obtain the drag reduction formulation.

In an aspect of the present invention, the polymers in the cryogrinding step comprise one or more polyalphaolefin in an amount of 15 wt % to 25 wt %; and one or more olefin co-polymer (OCP) in an amount of 10 wt. % to 20 wt. %.

In an aspect of the present invention, the dispersion medium in step (ii) comprises one or more fatty acid oil in an amount of 40 wt. % to 50 wt. %; and one or more dispersion agent in an amount of 1 wt. % to 5 wt. %, wherein the fatty acid oil is a vegetable oil selected from a group comprising castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof; and wherein the dispersion agent is selected from a group comprising 1-pentanol, 1-hexanol, 1-heptanol, n-octyl alcohol, n-nonyl alcohol, 1-decanol, and a combination thereof.

In another aspect of the present invention, the ionomer in step (ii) is selected from a sodium, or a lithium or a zinc salt of ethylene-methacrylic acid, ethylene-acrylic acid, ethylene-co-methacrylic acid, poly(ethylene-co-methacrylic acid), and a combination thereof.

In yet another aspect of the present invention, the partitioning agent in step (ii) is selected from a group comprising calcium stearate, magnesium stearate, zinc stearate, sodium stearate, clay, talc, silica, micronized wax, sodium stearyl fumarate, sodium behenate, and a combination thereof.

In still another aspect of the present invention, the additives in step (ii) are shear stabilizing agents selected from a group comprising sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.

In another aspect, the present invention provides a method for reducing the drag in a fluid system specifically hydrocarbon flowing in a pipeline or a conduit. The method is characterized by the steps of: (A) preparing a drag reduction formulation by (a) cryogrinding of polymers in liquid nitrogen to obtain a mixture of polymer particles; (b) separating the mixture of polymer particles in a size range of 300 μm to 600 μm followed by addition of a dispersion medium in an amount of 40 wt. % to 55 wt. %, one or more ionomer in an amount of 1 wt. % to 10 wt. %, one or more partitioning agent in an amount of 5 wt. % to 15 wt. %, and one or more additives in an amount of 0.1 wt. % to 1 wt. % to obtain a mixture; and (c) homogenizing the mixture to obtain the drag reduction formulation (DRF); and (B) feeding the drag reduction formulation into a hydrocarbon transporting pipeline or conduit in an amount of 1-20 ppm, preferably 1-10 ppm, most preferably 1-5 ppm.

In an aspect of the present invention, the polymers in the cryogrinding step comprise one or more polyalphaolefin in an amount of 15 wt. % to 25 wt. %; and one or more olefin co-polymer (OCP) in an amount of 10 wt. % to 20 wt. %.

In an aspect of the present invention, the dispersion medium in step (b) comprises one or more fatty acid oil in an amount of 40 wt. % to 50 wt. %; and one or more dispersion agent in an amount of 1 wt. % to 5 wt. %, wherein the fatty acid oil is a vegetable oil selected from a group comprising castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof; and wherein the dispersion agent is selected from a group comprising 1-pentanol, 1-hexanol, 1-heptanol, n-octyl alcohol, n-nonyl alcohol, 1-decanol, and a combination thereof.

In another aspect of the present invention, the ionomer in step (b) is selected from a sodium, or a lithium or a zinc salt of ethylene-methacrylic acid, ethylene-acrylic acid, ethylene-co-methacrylic acid, poly(ethylene-co-methacrylic acid), and a combination thereof.

In yet another aspect of the present invention, the partitioning agent in step (b) is selected from a group comprising calcium stearate, magnesium stearate, zinc stearate, sodium stearate, clay, talc, silica, micronized wax, sodium stearyl fumarate, sodium behenate, and a combination thereof.

In still another aspect of the present invention, the additives in step (b) are shear stabilizing agents selected from a group comprising sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.

In an aspect of the present invention, the drag reduction formulation exhibits better drag reduction performance with a good dispersion stability and an enhanced shear stability.

In yet another aspect of the present invention, the drag reduction formulation exhibits enhanced drag reduction with an excellent stabilization over the wider shear range at a very low concentration.

The following examples, in which the parts and percentages are on a weight basis, unless otherwise indicated, are merely provided to illustrate the invention.

### Example 1

### Preparation of Drag Reduction Formulations

To develop drag reduction formulations having improved characteristics, a careful selection of different constituents in respective percentage was carried out. The components of the Drag Reduction Formulation (DRF) tabulated in Table 1:

TABLE 1
COMPONENTS OF THE DRAG REDUCTION
FORMULATIONS (DRFS)

| S. No. | Component | Amount |
|---|---|---|
| 1 | Dispersion medium | 40 wt. % to 55 wt. % |
| 2 | α-Olefin polymer (OP) | 15 wt. % to 25 wt. % |
| 3 | Olefin Co-polymer (OCP) | 10 wt. % to 20 wt. % |
| 4 | Ionomer | 1 wt. % to 10 wt. % |
| 5 | Partitioning Agent | 5 wt. % to 15 wt. % |
| 6 | Other Additives | 0.1 wt. % to 1 wt. % |

In the drag reduction formulation of Table 1, the key constituents with their synergistic contributions are as follow: 1) Polyalphaolefin (Poly α-olefin polymer): The ultrahigh molecular weight polyalphaolefin plays a crucial role in enhancing drag reduction/resistance properties, particularly in reducing the frictional resistance in pipelines, as the ultrahigh molecular weight of polyalphaolefin allows it to interact effectively with the fluid (diesel or any other hydrocarbon) molecules flowing the in pipelines. The long alpha olefin chains of the polyalphaolefin create a network that alters the flow characteristics of the fluid. In addition, hydrophobic nature of the polyalphaolefin allows it to disperse in the fluid and ensure uniform distribution throughout of the fluid as a result help to achieve dispersion stability to the formulation. 2) Ionomers: Ionomers are polymers that contain a small number of ionic groups attached to their backbone i.e. a sodium, or a lithium or a zinc ions, on ethylene-methacrylate ion, or ethylene-acrylate ion, or ethylene-co-methacrylate ion, or poly(ethylene-co-methacrylate) ion. These ionic groups form reversible cross-links and leading to the formation of a network structure within the polymer. This network significantly alters the flow properties of the polymer solution, reducing turbulence and thereby lowering drag. In addition, the ionic interactions within the ionomer provide a balance between elasticity and flexibility. This balance helps to maintain the structure of the drag reduction formulation under shear forces, such as those encountered in pipeline flow, thus contributing to drag reduction. 3) Olefin Copolymer: The olefin copolymer modifies the rheological properties of the fluid (diesel or hydrocarbons), such as its viscosity and elasticity. This modification reduces the energy loss due to turbulence, thus enhancing the overall drag reduction.

### Example 2: Optimization and Effect of Different Components of the Drag Reduction Formulation

### Lab Scale Evaluation of Drag Reduction Efficiency of the Drag Reduction Formulations

The drag reduction formulation of the present invention was fed into a diesel pipeline and the drag reduction efficiency of the formulation was calculated using Anton Paar Rheometer-MCR 702 with CC27/T200/SS Measuring Cell. The percentage drag reduction efficiency is calculated using the formula mentioned below:

$$DR \% = \frac{{T}_{s} - {T}_{p}}{{T}_{s}}$$

wherein, Tₛ is torque of diesel at 30° C., and Tₚ is the torque of drag reduction formulation/diesel solution at 30° C.

While evaluating the drag reduction efficacy of the formulations of the Example 1, the concentrations of the components (ingredients) viz. the polyalphaolefin, the ionomers and the olefin-co-polymers of the formulation found to show a synergic effect. Optimized concentrations and the drag reduction efficacy of the drag reduction formulation is tabulated in the Table 2. The drag reduction formulations of Table 2 comprises: 15 wt. % to 25 wt. % of the polyalphaolefin, 1 wt. % to 5 wt. % of the ionomers, and 10 wt. % to 20 wt. % of the olefin co-polymer (wherein the olefin co-polymer is present 10 wt. % to 50 wt. % with respect to the total polymer used in the drag reduction formulation), wherein the wt. % is based on the total weight of the drag reduction formulation:

TABLE 2
EFFECT OF IONOMER CONCENTRATION
ON DRAG REDUCTION EFFICIENCY

| | Ionomer Conc.(wt. %) | | | | | |
|---|---|---|---|---|---|---|
| | 0 | 1 | 2 | 3 | 4 | 5 |
| Shear Rate (1/s) | % Drag Reduction | | | | | |
| 2.00E+03 | 5.58 | 19.13 | 14.28 | 13.73 | 11.75 | 5.52 |
| 2.50E+03 | 11.18 | 19.04 | 16.18 | 15.61 | 11.18 | 6.64 |
| 2.99E+03 | 15.73 | 19.32 | 16.27 | 16.07 | 11.97 | 12.17 |
| 3.65E+03 | 17.68 | 18.81 | 16.44 | 15.83 | 12.78 | 11.09 |

Results under Table 2 suggest that the drag reduction formulations having 15 wt. % to 25 wt. % of the polyalphaolefin, and 10 wt. % to 20 wt. % of the olefin co-polymer, at an ionomer concentration of 1 wt. % demonstrate a synergistic effect among the components and show maximum drag reduction at said concentration of the components. In addition, the drag reduction formulation achieves an enhanced drag reduction over a wider shear range with an excellent stabilization even at very low concentration. However, the drag reduction efficiency calculated at lab scale is only an indicative result.

The drag reduction formulation described herein with specific constituents in specific percentages, particularly specifically identified percentages of the polyalphaolefin, the ionomer & the olefin copolymer results in unexpected synergistic effect in terms of improved drag reduction. As the network structure provided by the ionomers, combined with the high molecular weight and flow-altering properties of the olefin copolymers, results in a more effective drag reduction. Further, the polyalphaolefin reduces turbulence, therefore provides shear stability and allows smooth flow to the fluid in the pipeline. The interaction between the polyalphaolefin, the ionomer and the olefin copolymer enhance the stability of the drag reduction formulation in the fluid and ensure that the drag reduction effect is maintained over longer distances.

Overall, the combination of the polyalphaolefin, the ionomers and the olefin copolymers in drag reduction formulation is tailored to maximize the reduction in drag by altering the flow dynamics and reducing turbulence within pipelines.

### Example 3: Performance of Drag Reduction Formulation at Commercial Pipeline

In one of the exemplary formulation the drag reduction formulation (DRF) comprises 30 wt. % of active polymers (19 wt. % of the polyalphaolefin+1 wt. % of the ionomer+10 wt. % of the olefin co-polymer (OCP)), 55 wt. % of a dispersion medium (blend of linseed oil & 1-hexanol), and 15 wt. % of partitioning agent (calcium stearate).

The drag reduction formulations of Example 1 provide more than 20% to 40% drag reduction in diesel, when tested on a diesel pipeline up to 182 km, wherein the drag reduction formulation is added in a concentration of 1 ppm to 10 ppm in the diesel, preferably in a concentration of 2 ppm to 8 ppm, and more preferably in a concentration of 1 ppm to 5 ppm. Performance of the drag reduction formulations is tabulated in Table 2. Percent (%) Drag Reduction is calculated by using the formula mentioned below:

$$Percent Drag Reduction ( \% DR ) = ( f 1 - f 2 ) / f 1 * 100$$

wherein, f1 is friction loss in the pipeline without employing a drag reduction formulation (DRF) injection, and f2 is friction loss in the pipeline on employment of the drag reduction formulation (DRF) injection.

TABLE 2
PERFORMANCE OF THE DRAG REDUCTION
FORMULATIONS (DRFS)

| Sr. No. | Dosage (ppm) | % Drag Reduction |
|---|---|---|
| 1 | 8 | 41.39 |
| 2 | 5 | 33.94 |
| 3 | 3 | 23.50 |

Results of the Table 2 suggest that the percent drag reduction by the Drag Reduction Formulations of the present invention, is more than 20% even at a lower dosage i.e. the drag reduction formulation (DRF) at a dosage of 3 ppm provides a drag reduction of 23.50% to the hydrocarbon (diesel).

Advantages of the Drag Reduction Formulation of the Present Invention:
The invention provides a novel drag reduction formulation with good dispersion ability.
The drag reduction formulation of the present invention provides efficient drag reduction.
The drag reduction formulation of the present invention achieves an enhanced drag reduction with an excellent stabilization over a wider shear range even at very low concentration.
The drag reduction formulation of the present invention comprising of the olefin-co-polymer which offers rheology-control to the formulation.
Incorporation of the shear stabilizing agent in the drag reduction formulation of the present invention offers high shear strength during turbulence.
Incorporation of the ionomers in the polymers viz. polyalphaolefin and olefin-co-polymer provides a synergic effect to the drag reduction formulation and provides a better drag reduction performance at very low concentration without compromising other properties viz. dispersion stability, and shear stability, in petroleum finished products while transporting the petroleum finished products through pipelines or conduits in a short-to-long range distances.

1. A drag reduction formulation (DRF) comprising:
a) a dispersion medium in an amount of 40 wt. % to 55 wt. %;
b) one or more α-olefin polymer in an amount of 15 wt. % to 25 wt. %;
c) one or more olefin co-polymer in an amount of 10 wt. % to 20 wt. %;
d) one or more ionomer in an amount of 1 wt. % to 10 wt. %;
e) one or more partitioning agent in an amount of 5 wt. % to 15 wt. %; and
f) one or more additives in an amount of 0.1 wt. % to 1 wt. %.

2. The formulation as claimed in claim 1, wherein the dispersion medium comprises one or more fatty acid oils in an amount of 40 wt. % to 50 wt. %; and one or more dispersion agents in an amount of 1 wt. % to 5 wt. %, wherein the fatty acid oil is a vegetable oil selected from a group consisting of castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof, and wherein the dispersion agent is selected from a group consisting of 1-pentanol, 1-hexanol, 1-heptanol, n-octyl alcohol, n-nonyl alcohol, 1-decanol, and a combination thereof.

3. The formulation as claimed in claim 1, wherein the α-olefin polymer is an ultrahigh molecular weight polyalphaolefin polymer having a molecular weight more than 1.0×10⁷ Da and is selected from a group consisting of poly(l-decene), poly(l-octene), poly(l-hexene), co-polymers thereof and a combination thereof; and wherein the olefin co-polymer (OCP) has a molecular weight not more than 1.5×10⁶ Da and is selected from a group consisting of ethylene-co-propylene polymer, ethylene-co-vinylene polymer, hexene-co-dodecene polymer, octene-co-tetradodecene polymer, ethylene-1-butene copolymer, ethylene-1-hexene copolymer, and a combination thereof.

4. The formulation as claimed in claim 1, wherein the ionomer is selected from a sodium, or a lithium or a zinc salt of ethylene-methacrylic acid, ethylene-acrylic acid, ethylene-co-methacrylic acid, poly(ethylene-co-methacrylic acid), and a combination thereof.

5. The formulation as claimed in claim 1, wherein the partitioning agent is selected from a group consisting of calcium stearate, magnesium stearate, zinc stearate, sodium stearate, clay, talc, silica, micronized wax, sodium stearyl fumarate, sodium behenate, and a combination thereof.

6. The formulation as claimed in claim 1, wherein the additives are shear stabilizing agents selected from a group consisting of sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.

7. A method for preparing a drag reduction formulation (DRF), said method comprising:
(i) cryogrinding of polymers to obtain a mixture of polymer particles;
(ii) separating the mixture of polymer particles in a size range of 300 μm to 600 μm followed by addition of a dispersion medium in an amount of 40 wt. % to 55 wt. %, one or more ionomer in an amount of 1 wt. % to 10 wt. %, one or more partitioning agent in an amount of 5 wt. % to 15 wt. %, and one or more additives in an amount of 0.1 wt. % to 1 wt. % to obtain a mixture; and
(iii) homogenizing the mixture to obtain the drag reducing formulation.

8. The process as claimed in claim 7, wherein cryogrinding of polymers is carried out in liquid nitrogen and wherein the polymers consist of one or more polyalphaolefin in an amount of 15 wt. % to 25 wt. %; and one or more olefin co-polymer (OCP) in an amount of 10 wt. % to 20 wt. %.

9. The process as claimed in claim 7, wherein the dispersion medium in step (ii) comprises one or more fatty acid oil in an amount of 40 wt. % to 50 wt. %; and one or more dispersion agent in an amount of 1 wt. % to 5 wt. %, wherein the fatty acid oil is a vegetable oil selected from a group consisting of castor oil, colza oil, corn oil, cottonseed oil, hemp oil, mustard oil, palm oil, peanut oil, radish oil, rapeseed oil, canola oil, ramtil oil, rice bran oil, safflower oil, salicornia oil, soybean oil, sunflower oil, tigernut oil, tung oil, sesame oil, nut oils, citrus oils, melon seed oil, pumpkin seed oil, flaxseed oil, linseed oil, palm oil, olive oil, perilla oil, and a combination thereof; and wherein the dispersion agent is selected from a group consisting of 1-pentanol, 1-hexanol, 1-heptanol, n-octyl alcohol, n-nonyl alcohol, 1-decanol, and a combination thereof.

10. The process as claimed in claim 7, wherein the ionomer in step (ii) is selected from a sodium, or a lithium or a zinc salt of ethylene-methacrylic acid, ethylene-acrylic acid, ethylene-co-methacrylic acid, and poly(ethylene-co-methacrylic acid); wherein the partitioning agent in step (ii) is selected from a group consisting of calcium stearate, magnesium stearate, zinc stearate, sodium stearate, clay, talc, silica, micronized wax, sodium stearyl fumarate, sodium behenate, and a combination thereof; and wherein the additives in step (ii) are shear stabilizing agents selected from a group consisting of sodium lauryl sulfate, sodium decyl sulfate, sodium tetradecyl sulfate, alkylbenzene sulfonates, cetyl trimethyl ammonium bromide, cetyl trimethyl ammonium chloride, benzalkonium chloride, and a combination thereof.
